(19) United States
(12) Patent Application Publication
(10) Pub. No.: US 2026/0077508 A1
(43) Pub. Date: Mar. 19, 2026

(54) GUIDE ROBOT AND OPERATION METHOD OF GUIDE ROBOT

(71) Applicant: LG ELECTRONICS INC., Seoul (KR)

(72) Inventors: Mihyun PARK, Seoul (KR); Hyeongjin KIM, Seoul (KR); Junghyun LEE, Seoul (KR)

(73) Assignee: LG ELECTRONICS INC., Seoul (KR)

(21) Appl. No.: 19/109,098

(22) PCT Filed: Sep. 8, 2022
(86) PCT No.: PCT/KR2022/013568

§ 371 Date: Mar. 5, 2025

(51) Int. Cl. B25J 11/00; B25J 9/16

(52) U.S. Cl. CPC B25J 11/0005; B25J 9/1697

(57) ABSTRACT

A guide robot and an operation method of same are disclosed. A guide robot according to the present disclosure may, although having recognized a pre-stored designated position in order to perform a docent function, determine whether or not to modify the designated position on the basis of information on surrounding visitors, and even after having moved to the determined designated position, adjust a detailed position, posture, angle, and line of sight according to visitor information. In addition, a next operation may be determined on the basis of visitor information which is updated during an utterance about an object to be exhibited. Accordingly, a smarter docent service can be provided to a visitor.

### TECHNICAL FIELD

The present disclosure relates to a guidance robot and a method of operating the guidance robot and, more particularly, to a guidance robot capable of performing the function of explaining a target exhibition and providing guidance to the target exhibition within a predetermined space, and a method of operating the guidance robot.

### BACKGROUND ART

In recent years, there has been ever-increasing interest in guidance robots providing various guidance services to users. While autonomously traveling without user operation, for example, guidance robots provide various guidance services to users by performing a voice conversation function or an interaction function using a touchscreen.

One of the functions of a guidance robot is the docent function of explaining a specific target object or providing guidance to the specific target object. In order to perform the docent function, the guidance robot pre-stores a guided viewing path and a designated location of the guidance robot. When the docent function begins, the guidance robot moves to a designated location along the designated guided viewing path and explains a specific target object or provides guidance to the specific target object.

Normally, the designated location of the guidance robot for performing the docent function is defined as either the central position on a specific target object or an arbitrary position within a predetermined range (that is, a margin range) in the vicinity of the center position.

At this point, in a case where a visitor is already present at the designated location of the guidance robot or where the vicinity of the designated location is congested, the guidance robot may be unable to reach the designated location, thereby delaying the explanation. Alternatively, the guidance robot frequently recognizes a visitor as an obstacle and requests the visitor to step aside, thereby causing inconvenience to the user.

In addition, similar to a human docent, the guidance robot cannot flexibly adjust the level of explanation, considering factors such as the number, gender, and age bracket of gathered visitors. As a result, the explanation may feel less engaging and harder to understand.

In addition, in the case of the guidance robot, unlike a human docent, visitors may be unable to easily concentrate on the explanation or may move away before the explanation is finished. Even in this situation, the guidance robot continues providing viewing guidance as stored, thereby reducing engagement and focus.

### DISCLOSURE OF INVENTION

### Technical Problem

One object of one or several embodiments of the present disclosure is to provide a guidance robot capable of varying a designated location more flexibly and adaptively in such a manner as to reach the designated location and moving the designated location to provide a service, even in a case where visitors are already present at the designated location or where the vicinity of the designated location is congested, and a method of operating the guidance robot. The guidance robot and the method of operating the guidance robot are capable of proceeding with the function of explaining an exhibition, without any delay.

Another object of one or several embodiments of the present disclosure is to provide a guidance robot capable of monitoring the external characteristics of a visitor, the degree of visitor congestion, or the degree of visitor concentration on the explanation, flexibly modifying content or a viewing path, and accordingly providing guidance along the viewing path for viewing the content, and a method of operating the guidance robot.

Still another object of one or several embodiments of the present disclosure is to provide a guidance robot capable of dynamically adapting to various situations in such a manner as to maintain maximum visitor concentration, even during explanation delivery or movement to the next exhibition, and a method of operating the guidance robot.

Still another object of one or several embodiments of the present disclosure is to provide a guidance robot capable of autonomously determining and performing an operation appropriate for a visitor's behavioral change or a change in the number of visitors, without additional input, while performing a function of explaining an exhibition, and a method of operating the guidance robot.

### Solution to Problem

A guidance robot according to the present disclosure is capable of determining whether or not to modify a designated location based on visitor information in the vicinity, although the guidance robot recognizes the designated location pre-stored to perform a docent function, and of adjusting the detailed location, the posture, the angle, and the gaze even after moving to the determined designated location.

In addition, a guidance robot according to the present disclosure is capable of changing content for an utterance according to the characteristics of a visitor in the vicinity, the visitor's behavioral change, or the degree of visitor congestion, or of changing operations associated with viewing, such as modifying a guided viewing path and changing the next exhibition,

More specifically, according to one aspect of the present disclosure, there is provided a guidance robot including: a sensor for acquiring visitor information in the vicinity, which is to be referenced at the current location of the guidance robot; a processor that determines an arrival location associated with a target exhibition based on the visitor information; and a traveling-enabling unit for moving the guidance robot to the determined arrival location. In the guidance robot, the processor adjusts the posture or gazing direction of the guidance robot at the determined arrival location in such a manner as to correspond to the facial direction of a visitor included in the visitor information, and determines the next operation on the basis of the visitor information updated during an utterance about the target exhibition.

In addition, in one embodiment, in the guidance robot, the processor may determine at the determined arrival location whether or not the detailed location of the guidance robot needs to be adjusted, based on the degree of congestion in the vicinity of the target exhibition, and, after moving or identifying the detailed location according to the determination, may adjust the posture or gazing direction of the guidance robot.

In addition, in one embodiment, in the guidance robot, in response to the degree of congestion in the vicinity of the target exhibition reaching or exceeding a predetermined range, by controlling the traveling-enabling unit, the processor may adjust the detailed location of the guidance robot in such a manner as to be located at a point located a predetermined distance from the visitor in the vicinity of the target exhibition, and may adjust the angle of the guidance robot in such a manner that the guidance robot faces the target exhibition.

In addition, in one embodiment, in the guidance robot, when it is determined that the guidance robot is unable to move to candidate points in a first group, which correspond to a POI that is input in advance, the processor may determine one of candidate points in a second group, which correspond to the arrival location of the guidance robot, which is determined based on the visitor information, as the detailed location of the guidance robot, and the relationships among the candidate points in the second group may correspond to the relationships among the candidate points in the first group.

In addition, in one embodiment, the guidance robot may further a display that is mounted on the front-facing surface of the body of the guidance robot and displays visual information associated with the target exhibition, wherein, in response to the degree of congestion in the vicinity of the target exhibition reaching or exceeding the predetermined range, the processor may rotate the front-facing surface of the body of the guidance robot in such a manner that the display faces the direction in which the degree of congestion is at or below average.

In addition, in one embodiment, in the guidance robot, the sensor for acquiring the visitor information may include one or more of the following: a camera, a 3D depth camera, a LiDAR, or a proximity sensor.

In addition, in one embodiment, in the guidance robot, the guidance robot may be divided into a head unit including a first display that is positioned on the upper portion and displays a change in the facial expression of the guidance robot, and a body unit including a second display that is positioned between the head unit and the traveling-enabling unit and displays visual information associated with an explanation about the target exhibition, and the processor may align the center of the body unit in such a manner that the second display faces the facial direction of the visitor included in the visitor information, and may control the display on the first display on the basis of the facial density distribution, which is included in the visitor information monitored during the utterance, in such a manner as to change the attention focus direction of the guidance robot.

In addition, in one embodiment, in the guidance robot, the processor may adjust the attention focus direction of the guidance robot by controlling the first display in such a manner that the guidance robot focuses attention on a point or region where the density distribution of the faces of the visitors is at or above average, for an extended period.

In addition, in one embodiment, in the guidance robot, when the guidance robot moves to the determined arrival location, the processor may adjust the traveling speed of the guidance robot through the traveling-enabling unit in such a manner that the guidance robot maintains a predetermined distance from a visitor.

In addition, in one embodiment, the guidance robot may further include a speaker that is mounted on the guidance robot and outputs an utterance about the target exhibition, wherein, before the utterance about the target exhibition begins, the processor may analyze the characteristics of a visitor, corresponding to the visitor information, and may adjust at least one of the following: the type of voice for the utterance, the volume of the utterance, or the speed of the utterance.

In addition, in one embodiment, in the guidance robot, the processor may analyze a visitor's facial expression or behavioral change, which is included in the visitor information, and, on the basis of the degree of concentration during viewing, resulting from the analysis, may determine whether or not to change the content of an utterance about the target exhibition or to adjust the duration of the utterance.

In addition, in one embodiment, the guidance robot may further include a memory in which a viewing path, along which the guidance robot provides guidance within a predetermined space, and information about the target exhibition are stored, wherein the processor may determine whether or not to modify the stored viewing path, based on the degree of congestion, which is included the visitor information, and may determine whether or not change the next target exhibition, based on the degree of congestion in the vicinity of the target exhibition to be explained.

In addition, in one embodiment, in the guidance robot, the processor may determine whether or not to change the stored viewing path or a stipulated regulatory guidance approach, on the basis of the characteristics of a visitor, which are included in the visitor information.

In addition, in one embodiment, in the guidance robot, the processor may determine whether or not to provide guidance to the next target exhibition, on the basis of the number of remaining visitors, which is included in updated the visitor information, during an utterance about the target exhibition.

In addition, in one embodiment, in the guidance robot, when it is determined through the sensor that the number of remaining visitors, which is included in the updated visitor information, is not present, the processor may recognize that guidance along the viewing path is complete and may terminate viewing guidance without providing guidance to the next target exhibition.

According to another aspect of the present disclosure, there is a method of operating a guidance robot, which is configured to include the following steps. The method of operating a guidance robot includes: a step of acquiring visitor information in the vicinity; a step of determining an arrival location associated with a target exhibition on the basis of the visitor information and moving the guidance robot to the determined arrival location; a step of adjusting the posture or gazing direction of the guidance robot in such a manner as to correspond to the facial direction of a visitor included in the visitor information; and a step of determining the next operation based on the visitor information updated during an utterance about the target exhibition.

In addition, in one embodiment, in the method, the step of determining the arrival location associated with the target exhibition and moving the guidance robot to the determined arrival location may include: a step of determining whether or not to modify the arrival location associated with the target exhibition according to the degree of congestion, which is included in the visitor information; a step of moving the guidance robot to the next arrival location while maintaining a predetermined distance from the visitor; and a step of modifying the arrival location or the posture of the guidance robot on the basis of the degree of congestion in the vicinity of the target exhibition.

In addition, in one embodiment, in the method, the step of the posture or gazing direction of the guidance robot in such a manner as to correspond to the facial direction of the visitor, which is included in the visitor information, may include: a step of monitoring the face of the visitor at the arrival location through a sensor; a step of modifying the arrival location or performing a predetermined motion at the current location, on the basis of the result of the monitoring; a step of adjusting the type of voice for the utterance, the volume of the utterance, or the speed of the utterance, on the basis of the result of the monitoring; and a step of beginning the utterance while moving the head of the guidance robot or the gazing direction of the pupils of the guidance robot leftward and rightward in such a manner that the guidance robot focuses attention on a location or region where a large number of visitors are present, for an extended period.

In addition, in one embodiment, in the method, the step of determining the next operation on the basis of the visitor information updated during the utterance about the target exhibition may include: a step of analyzing the visitor's facial expression or behavioral change, which is included in the updated visitor information, and determining whether or not to modify the content of the utterance or the duration of the utterance, on the basis of the degree of concentration during viewing, resulting from the analysis; a step of determining whether or not to change a guided viewing path or the next target exhibition, based on the degree of congestion, which is included in the updated visitor information; and a step of determining whether or not to terminate viewing guidance, based on the number of visitors, which is included in the updated visitor information.

### Advantageous Effects of Invention

The guidance robot according to one or several embodiments of the present disclosure and a method of operating the guidance robot can modify a pre-stored designated location according to the number of visitors in the vicinity, which is included in the visitor information, and the degree of congestion in the vicinity. Even after the guidance robot moves to the corresponding location, according to the direction in which a visitor gazes, the degree of congestion, and the location of the target exhibition, the guidance robot and the method of operating the guidance robot can adjust the detailed location or can appropriately adjust the posture, angle, and gazing direction of the guidance robot. Accordingly, visitors provided with the service can feel a sense of friendliness, similar to when a human docent provides guidance, and concentrate on viewing.

In addition, the guidance robot according to one or several embodiments of the present disclosure and the method of operating the guidance robot can enable the monitoring of the characteristics of visitors who gather in the vicinity of the target exhibition, thereby accordingly delivering an utterance using the type of voice, the volume, and the speed. Furthermore, the guidance robot and the method of operating the guidance robot can enable the monitoring of the degree of a visitor's congestion during viewing, thereby adjusting the utterance content or the utterance duration. As a result, the degree of a visitor's concentration during viewing and the degree of a visitor's comprehension of the content be enhanced.

In addition, the guidance robot according to one or several embodiments of the present disclosure and the method of operating the guidance robot can flexibly modify the stored guided viewing path or the next target exhibition to be explained according to the degree of congestion during viewing, thereby enhancing the docent effect.

In addition, in the guidance robot according to one or several embodiments of the present disclosure and the method of operating the guidance robot, when moving to the next target exhibition, the guidance robot can travel in accordance with the moving speed of a visitor, thereby proceeding to the next explanation without any delay. As a result, visitors receiving a docent service can remain fully attentive to the explanation.

In addition, in the guidance robot according to one or several embodiments of the present disclosure and the method of operating the guidance robot, while the viewing guidance is in progress, if it is determined that the docent service no longer needs to be provided, such as when all visitors leave, the guidance robot can autonomously terminate the service without additional input from the manager and move to a waiting location. Accordingly, no unnecessary resources are wasted, and the illogical situation where the docent service is continuously provided despite no visitors being present is eliminated.

### BRIEF DESCRIPTION OF DRAWINGS

FIG. 1 is a view illustrating an example of a guidance robot according to the present disclosure.

FIG. 2 is a block diagram illustrating an exemplary configuration of the guidance robot according to the present disclosure.

FIG. 3 is a view illustrating a situation where the guidance robot according to the present disclosure delivers an utterance for providing guidance for or an explanation about a target exhibition on the basis of visitor information.

FIG. 4 is a representative flowchart illustrating a method of operating the guidance robot according to the present disclosure.

FIGS. 5A, 5B, and 5C are conceptual diagrams, respectively, that are referenced to describe a scenario in which the guidance robot according to the present disclosure modifies an arrival location in detail based on the degree of congestion in the vicinity of the target exhibition, for which guidance is provided.

FIG. 6 is an exemplary conceptual diagram that is referenced to describe a scenario in which the guidance robot according to the present disclosure moves to the arrival location and then focuses attention on a location or region where a larger number of visitors are present, for an extended period.

FIGS. 7A, 7B, and 7C are conceptual views that are referenced to describe examples in which the guidance robot according to the present disclosure adjusts the gazing direction at the arrival location in such a manner as to correspond to the facial directions of visitors.

FIG. 8 is a flowchart illustrating detailed operations in which the guidance robot according to the present disclosure determines the arrival location associated with the target exhibition and moves to the determined location.

FIG. 9 is a flowchart illustrating the detailed operations associated with a scenario in which the guidance robot according to the present disclosure adjusts the posture or gazing direction according to the facial direction of a visitor after moving to the arrival location.

FIG. 10 is a flowchart illustrating the detailed operations associated with a scenario in which the guidance robot according to the present disclosure determines the next operation on the basis of the visitor information updated before, after, or while delivering an utterance about the target exhibition.

### MODE FOR THE INVENTION

A description will now be given in detail according to one or more embodiments disclosed herein, with reference to the accompanying drawings, and regardless of reference numerals, the same or similar components are given the same reference number, and descriptions thereof will be omitted. The terms “module” and “unit” as used herein interchangeably or individually used to refer to a constituent element only for convenience in description in the present specification and therefore are not themselves intended to take on different meanings or to depict different functions. In describing the embodiments disclosed herein, moreover, a detailed description of a related well-known technology will be omitted when it is determined that it would obscure the gist of the present disclosure. Furthermore, the accompanying drawings are provided only for a better understanding of the embodiments disclosed herein, and are not intended to limit the technical ideas disclosed herein. Therefore, it should be understood that the accompanying drawings include all modifications, equivalents, and substitutions within the scope and technical ideas of the disclosure.

The terms including an ordinal number such as first, second, and the like may be used to describe various elements, but the elements should not be limited by those terms. The terms are used merely for the purpose of distinguishing one element from another.

It will be understood that when an element is referred to as being “connected with” another element, the element can be connected with the another element or intervening elements may also be present. In contrast, when an element is referred to as being “directly connected with” another element, there are no intervening elements present.

As used herein, the singular form is intended to include the plural forms as well, unless context clearly indicates otherwise.

In the present application, it should be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

A “guidance robot” disclosed in the present specification refers to a robot capable of providing welcome greetings, path guidance, product guidance, parking guidance, library guidance, and various types of information, such as product search information, airport information, and docent information, to users in public places, including airports, shopping malls, such as department stores, accommodations, such as hotels, and cultural complexes, such as art museums and libraries.

In addition, the “guidance robot” disclosed in the present disclosure is capable of performing autonomous traveling to guide users to paths, specific places, and other destinations.

Particularly, the “guidance robot” disclosed in the present disclosure is capable of performing a function of providing an explanation associated with a target exhibition along a preset guidance path within a predetermined space, a function of guiding visitors to a viewing path and the like, a function of listening to and answering the visitor's inquiry, and other functions (these functions are hereinafter collectively referred to as a “docent function”). In addition, in one or several embodiments, the term “guidance robot” may be used to refer to a robot capable of performing the docent function.

In addition, the “guidance robot” disclosed in the present disclosure may include various output means associated with touchscreens, sound output units, LEDs, tactile sensors, and similar components to provide information or guidance in various forms (e.g., visual, auditory, and tactile).

In addition, “the target exhibition” disclosed in the present specification may encompass various types of exhibited articles that are subject to the guidance, interpretation, and explanation provided by the guidance robot. For example, the target exhibition may refer to works of art, art objects, exhibition items, artworks, new products, brand goods, and similar objects that are exhibited in predetermined spaces such as museums, art museums, galleries, memorial halls, showrooms, and flagship stores.

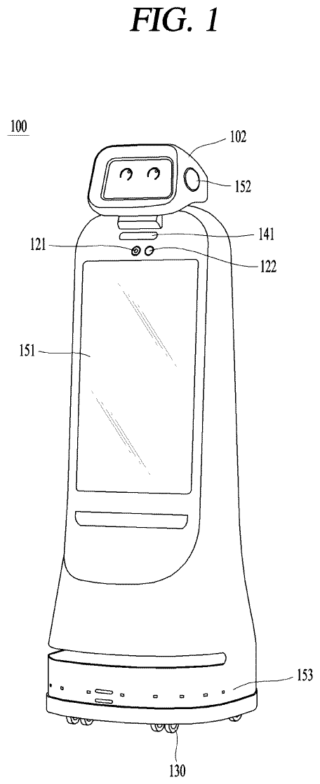

FIG. 1 is a view illustrating an example of a guidance robot according to the present disclosure.

With reference to FIG. 1, a guidance robot 100 according to the present disclosure may be configured to include a head 102, a camera 121, a speaker 152, a voice recognition unit (not illustrated), a touchscreen 151, and a traveling-enabling unit 130. However, depending on the application, the guidance robot 100 according to the present disclosure may be configured to omit one or more of the constituent elements disclosed in the present specification or to further include one or more constituent elements.

The exterior appearance of the guidance robot 100 according to the present disclosure may broadly include an upper module, which includes the head 102 and the touch screen 151, and a lower module, which includes the traveling-enabling unit 130. The upper module and the lower module may be provided in such a manner as to be detachably attached to each other.

The upper module provides a user interface that is changeable depending on service environments. The lower module provides traveling functionality for moving the main body of the guidance robot 100.

The upper module may include a body unit, which forms the main structure and includes the touchscreen 151, and the head unit 102, which includes the camera 121 or a similar component. However, depending on the application, the upper module may also be configured in such a manner that a camera is included in the body unit and that a touchscreen is arranged on the head unit 102.

The camera 121 may be provided on one side of the casing of the head unit 102 or on one side of the casing of the body unit. In addition, a plurality of cameras 121 may be provided. In this case, one camera 121 may be provided on the front surface of the main body and positioned to face forward. Another camera 121 may be provided on the lateral or rear surface and positioned to face sideways or backward. Accordingly, an angle of view covering 360 degrees can be formed.

In a case where a plurality of cameras 121 are provided, examples of a first camera may include a 3D stereo camera. The 3D stereo camera may perform functions such as obstacle detection, recognition of a user's face, and stereoscopic image capture. Using the first camera, the guidance robot 100 may detect and avoid an obstacle present in its moving direction and recognize a user, thereby performing various control operations. In addition, examples of a second camera may include a Simultaneous Localization And Mapping (SLAM) camera. The SLAM camera tracks the current location of a camera through feature mapping and performs a function of creating a 3D map based on this location. The guidance robot 100 may recognize its current location using the second camera.

In addition, the camera 121 may recognize an object within its angle of view and perform a function of capturing a still image and a moving image. In this regard, the camera 121 may include at least one of the following: a camera sensor (e.g., a CCD sensor, a CMOS sensor, or a similar type), a photo sensor (or image sensor), or a laser sensor. The camera 121 and the laser sensor may operate together to detect a touch on a 3D stereoscopic image by a detection target. The photo sensor may be stacked on a display element, and be configured to scan the motion of the detection target that approaches the touchscreen. More specifically, the photo sensor includes photodiodes and transistors (TRs) mounted in rows/columns, and thus scans an object placed on the photo sensor using an electric signal that varies with the amount of light applied to the photodiodes. That is, the photo sensor may compute the coordinates of the detection target that vary with a change in the amount of light, and acquire positional information of the detection target from these coordinates.

A sound output unit 152 performs a function of alerting the user to information to be provided, using voice and may, for example, take the form of a speaker. Specifically, a response or a search result, which corresponds to the user's voice received through a sound reception unit 122 and a voice recognition unit (not illustrated) included in the guidance robot 100, is output as voice through the sound output unit 152. The sound output unit 152 may be provided on the outer circumferential surface of the body unit, which includes the head unit 102 or the touchscreen 151. In addition, the sound output unit 152 may output voice information associated with a screen (e.g., a menu screen, an advertisement screen, or the like) displayed on the touch screen 151.

The sound reception unit 122 performs a function of receiving the user's voice or the like and may, for example, take the form of a microphone. The sound reception unit 122 may process an external sound signal into electrical voice data, and various noise elimination algorithms for eliminating noise that occurs in the process of inputting the external sound signal may be implemented.

The touchscreen 151 may be positioned in the lengthwise direction of the body unit that is one direction of the body unit, and display a screen to provide visual information, for example, guidance information. In addition, the touchscreen 151 may be configured to include a display module, a touch sensor, and a pressure sensor.

The touchscreen, for example, may be configured in such a manner as to open and close the inside of the body unit by being coupled to a movable guide mechanism. In addition, the touchscreen 151, for example, may also be configured in such a manner as to be fastened to the body unit and fixed using a fixation member.

In addition, although not illustrated in detail, the touchscreen 151 may be provided to face the opposite direction of the head 102, or the touchscreens 151 may be provided to face the direction of the head 102 and the opposite direction of the head 102, respectively. This configuration enables the guidance robot 100 to move along a preset path in advance of the user to provide guidance along a path. Alternatively, before moving along the preset path in advance of the user, the head 102 may also first rotate by 180 degrees and thus change its exterior appearance as if the touchscreen 151 were positioned to face the opposite direction of the head 102.

In this case, the touchscreen 151 performs a function of displaying visual information (e.g., path guidance information and inquiry information) associated with a currently provided service. The user can see the touch screen 151 installed on the rear side of the guidance robot 100 while moving along with the guidance robot 100.

In addition, the touchscreens 151 may be provided on both the front and rear surfaces, respectively, of the main body. In this case, different screens may be displayed on a first touchscreen, provided on the front surface of the main body, and a second touchscreen, provided on the rear surface of the main body, respectively (e.g., a screen for interacting with the user is displayed on the first touchscreen, and a screen for advertisement or the like is displayed on the second touchscreen). In addition, a display unit for outputting various facial expressions of the guidance robot may be provided on the front surface of the head unit 102.

The traveling-enabling unit 130 moves and rotates the main body of the guidance robot 100. To this end, the traveling-enabling unit 130 may be configured to include a plurality of wheels and a drive motor. A driving operation by the traveling-enabling unit 130 is controlled by a processor based on a received control command. An alert may be provided through an output means, such as LEDs, before or after the driving operation.

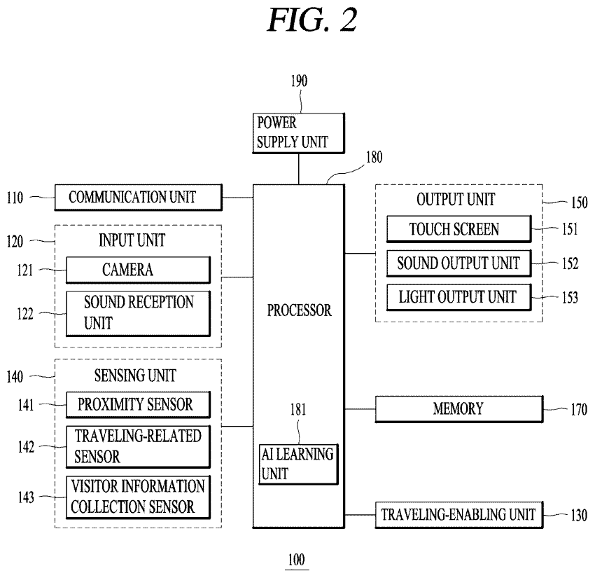

FIG. 2 is a block diagram illustrating an exemplary detailed configuration of the guidance robot according to the present disclosure.

The guidance robot 100 according to the present disclosure may include a communication unit 110, an input unit 120, the traveling-enabling unit 130, a sensing unit 140, an output unit 150, a memory 170, a processor 180, a power supply unit 190, and the like. The constituent elements illustrated in FIG. 2 are not essential for realizing the guidance robot. Therefore, the guidance robot described in the present specification may further include one or more constituent elements beyond those illustrated or may omit one or more of them.

The communication unit 110 may include one or more modules that enable wireless communication between the guidance robot 100 and an external server, for example, an artificial intelligence server, or between the guidance robot 100 and an external terminal. In addition, the communication unit 110 may include one or more modules that connect the guidance robot 100 to one or more networks.

The communication unit 110 may communicate with the artificial intelligence server or the like using wireless Internet communication technologies, for example, such as Wireless LAN (WLAN), Wireless Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), LTE-advanced (LTE-A) and others. The communication unit 110 may also communicate with an external terminal and other similar terminals by using short-range communication technologies, such as Bluetooth™, Radio Frequency Identification (RFID), Infrared Data Association (IrDA), Ultra Wideband (UWB), ZigBee, and Near Field Communication (NFC).

The input unit 120 may include a camera 121 or an image input unit for inputting an image signal, a sound reception unit 122 or a microphone for inputting an audio signal, and a user input unit (not illustrated) (e.g., a touch key, a mechanical key, or the like) for receiving information as input from a user. Signal data, voice data, and image data, which are collected by the input unit 120, may be analyzed and processed as control commands.

The traveling-enabling unit 130 moves and rotates the main body of the guidance robot 100. To this end, the traveling-enabling unit 130 may be configured to include a plurality of wheels and a drive motor. The driving operation by the traveling-enabling unit 130 is controlled by the processor 180 based on a received control command. An alert may be provided through a light output unit 153, such as LEDs, before or after the driving operation.

The sensing unit 140 may include at least one sensor for sensing at least one of the following: information within the guidance robot, information about surrounding environments near the guidance robot, or user-related information. For example, the sensing unit 140 may include at least one of the following sensors: a proximity sensor 141, an illumination sensor, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (e.g., refer to the camera 121), a microphone, a battery gauge, an environment sensor (e.g., a barometer, a hygrometer, a thermometer, a radiation detection sensor, a heat detection sensor, a gas detection sensor, or the like), or a chemical sensor (e.g., an electronic nose, a health care sensor, a biometric sensor, or the like). The guidance robot disclosed in the present specification may be utilized by combining pieces of information obtained from sensing from at least two of these sensors. In addition, the sensing unit 140 may include a traveling-related sensor 142 that detects an obstacle, a floor state, and the like.

Examples of the proximity sensor 141 may include a transmissive photoelectric sensor, a direct reflective photoelectric sensor, a mirror reflective photoelectric sensor, a high-frequency oscillation-type proximity sensor, a capacitance-type proximity sensor, a magnetic proximity sensor, an infrared proximity sensor, and other types of sensors. In addition, the proximity sensor 141 may include at least one of the following: a navigation camera, an ultrasonic sensor, a LiDAR, or a ToF sensor, and may recognize the approach and location of the detection target (e.g., the user) through this device.

In addition, the sensing unit 140 may include a visitor information collection sensor 143. The visitor information collection sensor 143 may include two or more sensors.

Examples of the visitor information collection sensor 143 may include one or more of the following: a camera, a 3D depth camera, LiDAR, or the proximity sensor 141. The visitor information collection sensor 143 may collect visitor information using one or more sensors. At this point, examples of the collected visitor information may include the following types of information: the degree of visitor congestion in a space, a visitor's facial direction, the visitor's external appearance, the density of visitors in the vicinity of the target exhibition, the degree of visitor concentration, visitor demographics, and the visitor's gender. In addition, the visitor information collection sensor 143 may detect changes in visitors, for example, when the number of visitors increases, when visitor demographics change, or when visitors move to other places.

The visitor information collected by the visitor information collection sensor 143 may be provided to the processor 180 or be stored in a memory 170.

The processor 180 may modify the arrival location of the guide robot 100, change its moving speed, or adjust its posture, angle, and gaze at the arrival location based on the received or stored visitor information or by analysis thereof. Furthermore, the processor 180 may deliver a docent-style utterance by selecting content details, the type of voice for an utterance, the volume, the speed, and other related factors that correspond to target visitor characteristics.

Based on the visitor information acquired continuously and in real time while performing the docent function, the processor 180 may also adjust utterance content or utterance duration and selectively change a guided viewing path or the next target exhibition.

The processor 180 may determine the degree of viewing congestion and/or the degree of congestion during viewing based on the visitor information and, depending on the result of the determination, decide whether or not to continue viewing guidance.

The output unit 150 serves to generate outputs associated with senses such as sight, hearing, and touch. The output unit 150 may include at least one of the following: the touchscreen 151, the sound output module 152, or the light output module 153. The touchscreen 151 may be configured to have either an interlayer structure or an integrated structure incorporating a touch sensor. The touchscreen may function as a user input unit, which provides an input interface between the guidance robot 100 and the user, and further provide an output interface.

As one example, voice for docent-style utterances may be output through the sound output unit 152, and either visual information associated with the target exhibition, guidance for which is provided through the touchscreen 151, or a prompt corresponding to the voice for docent-style utterances may be displayed.

The light output unit 153 outputs a signal for alerting the user to the occurrence of an event in the guidance robot 100, using light emitted by a light source. For example, in a case where a movement command is transferred to the traveling-enabling unit 130 of the guidance robot 100, a signal for alerting the user to the movement of the guidance robot 100 is output through the light output unit 153.

The processor 180 may include an AI learning unit 181 (not illustrated) to perform operations associated with artificial intelligence technologies for the guidance robot. The AI learning unit 181 may be configured to receive, classify, store, and output information that is used for data mining, data analysis, intelligent decision-making, and machine learning algorithms and technologies. The AI learning unit 181 may include one or more memory units. Each memory unit is configured to store information that is received, sensed, detected, generated, or predefined through the guidance robot, or information that is output in other ways through the guidance robot. Alternatively, each memory is configured to store data that are received, sensed, detected, generated, predefined, or output by another constituent element, an apparatus, and a terminal.

In one embodiment, the AI learning unit 181 may be integrated into the guidance robot or include the memory. In one embodiment, the AI learning unit 181 may be realized through the memory 170. However, the AI learning unit 181 is not limited thereto. The AL learning unit 181 may be realized either in an external memory associated with the guidance robot 100 or through a memory included in a server capable of communicating with the guidance robot 100. In another embodiment, the AI learning unit 181 may be realized through a memory maintained under a cloud computing environment or a remote memory accessible by the guidance robot through a communication technique such as over a network.

The AI learning unit 181 is configured to store data in one or more databases for purposes such as identification, indexation, classification, manipulation, storage, search and output. The data are typically used for supervised or unsupervised learning, data mining, prediction analysis, or other machine learning technologies. The information stored in the AI learning unit 181 may be used by the processor 180 or by a plurality of processors included in the guidance robot. The processor 180 and the plurality of processors use at least one of the following: analysis of different data types, machine learning algorithms, and machine learning technologies. Examples of these algorithms and techniques include k-Nearest neighbor system, fuzzy logic (e.g., possibility theory), neural networks, Boltzmann machines, vector quantization, pulsed neural nets, support vector machines, maximum margin classifiers, hill-climbing, inductive logic systems, Baysian networks, Petri nets (e.g., finite state machines, Mealy machines, and Moore finite state machines), classifier trees (e.g., perceptron trees, support vector trees, Markov trees, decision tree forests, and random forests), pandemonium models and systems, clustering, artificially intelligent planning, artificially intelligent forecasting, data fusion, sensor fusion, image fusion, reinforcement learning, augmented reality, pattern recognition, automated planning, and the like.

The processor 180 may determine or predict executable operations of the guidance robot on the basis of information that is determined or generated using data analysis, machine learning algorithms, and machine learning technologies. To this end, the processor 180 may request, search for, receive, or utilize the data stored in the AI learning unit 181. The processor 180 may perform various functions, such as realizing a knowledge-based system, an inference system, a knowledge acquirement system, and the like. Additionally, the processor 180 may perform various functions, such as realizing a system (e.g., a fuzzy logic system) for inference under uncertainty, an adaptive system, a machine learning system, an artificial intelligence network, and the like.

In addition, the processor 180 may include sub-modules, enabling voice and natural language processing, such as an I/O processing module, an environmental condition module, a voice-text (STT) processing module, a natural language processing module, an operation flow processing module, and a service processing module. In the guidance robot, each of the sub-modules may have the authority to access one or more systems, data, and models, or their subsets or supersets. At this point, objects that each of the sub-modules has the authority to access may include scheduling, a vocabulary index, user data, a task flow model, a service model, and an automatic speech recognition (ASR) system.

In one or several embodiments, on the basis of the data stored in the AI learning unit 181, the processor 180 may also be configured to sense and detect a user request by analyzing a contextual condition or the user's intention, which is expressed through user's input or natural language input. When an operation of the guidance robot is determined based on data analysis conducted by the AI learning unit 181, machine learning algorithms, and machine learning technologies, the processor 180 may control the constituent elements of the guidance robot to perform the determined operation. The processor 180 may perform the determined operation by controlling the guidance robot based on a control command.

The memory 170 stores data that support various functions of the guidance robot 100. The memory 170 may store a multiplicity of application programs (or applications) executed on the guidance robot 100, and data and commands for operating the guidance robot 100. In addition, the memory 170 may store a variable call word used for enabling a function of conducting a voice conversation with the user.

The memory 170 may store information, data, and programs, which are associated with the docent function of the guidance robot 100. Examples of the information or data associated with the docent function may include information or data about the guided viewing path, the target exhibition, and the designated location of each target exhibition.

Example of the memory 170 may include at least one of the following types of storage media: flash memory, hard disk, a solid state disk (SSD), silicon disk drive (SDD), a micro multimedia card, a card-type memory (e.g., SD or DX memory), Random Access Memory (RAM), Static Random Access Memory (SRAM), Read-Only Memory (ROM), Electrically Erasable Programmable Read-Only Memory (EEPROM), Programmable Read-Only memory (PROM), magnetic memory, magnetic disk, or optical disk.

The processor 180 typically controls the overall operation of the guidance robot 100 in addition to operations associated with the application program. The processor 180 may process signals, data, information, and the like that are input or output through the constituent elements described above, execute application programs stored in the memory 170, or control the traveling-enabling unit 130. By doing so, the processor 180 may provide information appropriate for the user or perform functions appropriate for the user.

Under the control of the processor 180, the power supply unit 190 is internally or externally supplied with electric power and distributes the electric power to the constituent elements included in the guidance robot 100. The power supply unit 190 may include a battery. The battery may be an internal battery or a replaceable battery.

At least one or several of the constituent elements may cooperate to operate or control the guidance robot, as described below in various embodiments, or to implement a method of controlling the guidance robot. In addition, the operating or controlling of the guidance robot, or the method of controlling the guidance robot may be performed in the guidance robot by executing at least one application program stored in the memory 170.

Various embodiments disclosed below may, for example, be implemented on a recording medium readable by a computer or a similar apparatus, using software, hardware, or any combination thereof.

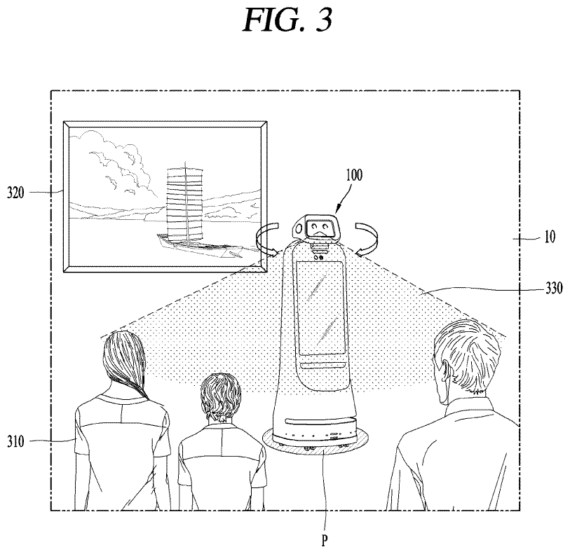

FIG. 3 is a view illustrating a situation where the guidance robot 100 according to the present disclosure delivers an utterance for providing guidance for or an explanation about the target exhibition on the basis of the visitor information.

When the docent function begins, the guidance robot 100 may determine the arrival location on the basis of the visitor information, move to the determined arrival location, and then repeatedly move after modifying its detailed location.

Specifically, the guidance robot 100 may acquire the visitor information in the vicinity through, for example, the visitor information collection sensor 143, which includes a camera, a proximity sensor, and the like.

For example, through the camera of the visitor information collection sensor 143, the face of the visitor in the vicinity may be recognized, and the visitor's facial direction, facial expression (mood), gender, age bracket, specific motion, and gesture may be detected. In addition, for example, the number of visitors and information about the distance between each visitor and the guidance robot 100 may be acquired through one of the following: a LiDAR, a proximity sensor, a 3D camera, or a typical camera, each of which is included in the visitor information collection sensor 143.

At this point, the visitor information may include the number of visitors, the degree of congestion during viewing, the distribution of visitors (for the target exhibition), a visitor's external appearance (e.g., gender, age bracket, whether a mask is worn, whether a stroller is carried, whether a visitor is accompanied by a child, and whether an assistive apparatus (a wheelchair or a pair of crutches) is used, and the like, all of which result from image analysis or the like. Furthermore, the visitor information may include a change in behavior, a change in facial expression, a gazing direction, and the like, all of which are obtained using face recognition algorithms. In addition, the visitor information may include the separation distance from the location of the guidance robot 100, that is, distance information. Furthermore, the visitor information may include facial direction, that is, angle information, which corresponds to the attention focus direction of the guidance robot 100.

Based on these various pieces of visitor information, the processor 180 (FIG. 2) of the guidance robot 100 may determine the arrival location of the guidance robot 100, taking into consideration the stored designated location.

For example, in a case where no congestion occurs in the vicinity of the stored designated location and no visitor is present, the guidance robot 100 may determine the stored designated location to be the arrival location. Conversely, for example, in a case where congestion occurs or a visitor or an obstacle is present at the designated location, another location or region that has a low degree of congestion during viewing and faces the target exhibition may be determined to be the arrival location.

In addition, for example, the arrival location may be modified according to the degree of congestion during viewing in a space 10. The degree of congestion during viewing may also be determined according to the analysis of the above-described visitor information. Specifically, the degree of congestion during viewing may be determined either by analyzing the number of visitors, which is included in the image acquired through the visitor information collection sensor 143 (FIG. 2), or on the basis of the current number of admitted visitors, which is received through the communication unit 110.

When the guidance robot 100 moves to the determined arrival location P using the traveling-enabling unit 130 (FIG. 2), at the determined arrival location, based on the visitor information about a visitor 310 present in the vicinity of the target exhibition 320, the processor 180 may determine whether or not to modify the detailed location of the guidance robot 100. Furthermore, the processor 180 may determine the robot's posture or gazing direction in such a manner as to correspond to the facial direction of the visitor 310.

To this end, at the arrival location P or the modified detailed location, the guidance robot 100 monitors the facial direction of the visitor 310 who is present within the camera's angle of view 330.

As a result of the monitoring, while maintaining a predetermined distance from the visitor 310, the guidance robot 100 modifies the posture to an angle that allows viewing of the target exhibition 320, and adjusts the gazing direction of the guidance robot 100 in such a manner as to make eye contact by aligning with the facial direction of the visitor 310. To this end, through the processor 180 of the guidance robot 100, the body unit on which the touchscreen 151 is provided may be controlled in such a manner as to rotate, and/or the body unit that expresses the facial expression and gazing of the guidance robot 151 may be controlled in such a manner as to rotate.

In order to enhance the monitored visitor 310's understanding of the explanation, the guidance robot 100 may analyze the external characteristics of the visitor 310 and, according to the analysis, may vary the type of voice (a child's voice, an adult's voice, or the like) for an utterance, the volume of an utterance (the magnitude of the utterance), and the speed of an utterance.

In addition, while delivering an utterance about the target exhibition 320, the guidance robot 100 may determine the next operation on the basis of the continuously updated visitor information.

For example, on the basis of the updated visitor information, the guidance robot 100 may not only additionally change the location for explanation (e.g., in a case where the number of visitors increases) or change the attention focus direction (e.g., in a case where a change in the density of visitors is detected), but also change the utterance content or the utterance duration.

In addition, for example, on the basis of the updated visitor information, the guidance robot 100 may change the next target object to be guided toward, modify the guided viewing path (or viewing guidance order), select guidance for the visitor's movement or restriction, or determine whether or not to terminate the viewing guidance.

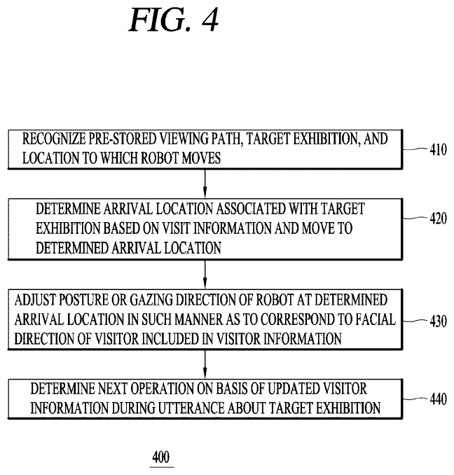

FIG. 4 is a representative flowchart illustrating a method of operating the guidance robot according to the present disclosure.

First, unless otherwise described, each step in the flowchart illustrated in FIG. 4 is assumed to be performed by the processor 180 of the guidance robot 100. In addition, according to the characteristics of providing a docent service, steps 410 to 440 illustrated in FIG. 4 may be repeatedly performed many times, for example, as many times as the number of the target exhibitions, until the docent service is terminated.

With reference to FIG. 4, when the docent function begins, the guidance robot 100 according to the present disclosure recognizes the viewing path, the target exhibition, and the location to which the robot moves, which are pre-stored in the memory or a similar storage device (410). This recognition is performed with respect to the current location.

The guidance robot 100 may determine the arrival location associated with the target exhibition based on the visitor information acquired through the sensor (e.g., the visitor information collection sensor 143), and through the traveling-enabling unit 130, move to the determined arrival location (420).

Specifically, in a state where the guidance robot 100 recognizes the stored target exhibition and the designated location for the stored target exhibition with respect to the current location, the guidance robot 100 determines whether or not to modify the designated location, based on the visitor information, and, according to this determination, determines the arrival location associated with the target exhibition.

When the arrival location is determined, by controlling the traveling-enabling unit 130, the guidance robot 100 adjusts its traveling speed in such a manner as to maintain a predetermined distance from visitors and moves to the determined arrival location. For example, while monitoring the moving speed of a visitor, the guidance robot 100 adjusts the traveling speed in such a manner as to stay close to the average moving speed (that is, not significantly lower or higher than the overall average moving speed) and moves to the arrival location. The traveling speed of the guidance robot 100 may be adjusted in accordance with the moving speed of the visitor in this manner, thereby enhancing the docent effect.

In addition, according to one embodiment, as the guidance robot 100 moves while maintaining a predetermined distance from visitors, the determined arrival location may also be modified based on the visitor information collected in real time. For example, in a case where a visitor arrives at the arrival location earlier than the guidance robot 100 or where one or more visitors move away or the number of visitors increases, the arrival location may be modified again accordingly.

When the guidance robot 100 arrives at the arrival location (or at the arrival location modified while the guidance robot 100 moves), the processor 180 adjusts the posture or gazing direction of the guidance robot 100 at the arrival location in such a manner as to correspond to the facial direction of a visitor included in the visitor information (430).

To this end, after moving to the determined arrival location, the processor 180 may recognize the faces of visitors gathering in the vicinity of the target exhibition and monitor the recognized faces and facial directions.

As a result of monitoring the faces and facial directions, before beginning an utterance about the target exhibition, the guidance robot 100 may prepare to begin the utterance by selecting the type of voice for an utterance, the volume of an utterance, and the speed of an utterance.

Specifically, on the basis of the result of monitoring the faces and facial directions, the guidance robot 100 may acquire visitor demographics (e.g., identifying whether visitors are family members, whether they include children, or whether they belong to a similar category), gender, and age bracket as the visitor information.

In addition, before beginning to deliver an utterance about the target exhibition, the processor 180 of the guidance robot 100 may analyze the characteristics of a visitor, which correspond to the visitor information, and, according to the analysis, adjust one or more of the following: the type of voice for an utterance, the volume of an utterance, or the speed of an utterance. The utterance is output through the speaker of the guidance robot 100.

Specifically, the guidance robot 100 may change or control a TTS engine that operates in conjunction with the guidance robot 100 in such a manner as to select the type of voice appropriate for the acquired visitor demographics and the visitor's acquired gender and age bracket. Furthermore, the guidance robot 100 may control the sound output unit 152 of the guidance robot 100 in such a manner as to output voice at the volume of an utterance and the speed of an utterance, which are appropriate for the visitor demographics and the visitor's gender and age bracket.

For example, in a case where the visitor demographics consist mostly of children, the docent-style utterance may be delivered using the TTS engine in a child's voice. In addition, for example, in a case where the visitor demographics indicate that the visitor belongs to an older age bracket, the docent-style utterance may be delivered by decreasing the speed of an utterance and increasing the volume of an utterance. Accordingly, the customized docent can be enabled. Thus, the docent effect can be enhanced, and the degree of a visitor's concentration during viewing can be improved.

Next, during an utterance about the target exhibition, the guidance robot 100 may adaptively determine the next operation to be performed, on the basis of the continuously updated visitor information (440).

According to one embodiment, the duration of the utterance about the target exhibition may include a preparation phase for the explanation about the target exhibition before the guidance robot 100 begins the explanation about the target exhibition. In addition, according to one embodiment, the duration of the utterance about the target exhibition may include a predetermined time before moving to the next target exhibition after the guidance robot 100 finishes explaining about the current target exhibition.

Therefore, examples of the next operation may include a specific operation and an operation that changes the current operation of the robot. The specific operation is determined to be appropriate for a situation, based on the visitor information collected while preparing for an utterance about a specific target exhibition, while delivering the utterance, and during a predetermined time after the utterance.

Specifically, as one embodiment, the processor 180 of the guidance robot 100 may analyze the facial expression and behavior of a visitor, which are included in the updated visitor information, and, according to the analysis, determine the degree of a visitor's concentration during viewing, thereby determining whether or not to modify the utterance content or the utterance duration. For example, when the facial expression of a visitor is determined to indicate boredom, the processor 180 may switch to more engaging content, allowing the docent-style utterance to continue.

In addition, as one embodiment, the processor 180 of the guidance robot 100 may change information about the content to be uttered, by analyzing the visitor's external characteristics included in the updated visitor information. For example, as a result of analyzing the visitor's external appearance, the guidance robot 100 may change the guided viewing path as a path along which the visitor moves comfortably and then guides the visitor along this path. Alternatively, the guidance robot 100 may provide an explanation about the regulatory guidance (e.g., No pets allowed, Child-free zone, and similar regulations).

In addition, as one embodiment, according to the degree of congestion included in the updated visitor information, the processor 180 of the guidance robot 100 may determine whether or not to change the guided viewing path or the next target exhibition. For example, in a case where an elevator is crowded, guidance may be provided in such a manner that visitors move to the next target exhibition using an alternative means (e.g., stairs). Alternatively, for example, in a case where the vicinity of the next target exhibition is very crowded, guidance may be provided for a viewing movement path in such a manner that an explanation about the next target exhibition may be skipped or postponed.

In addition, as one embodiment, based on the number of visitors, which is included in the updated visitor information, the processor 180 of the guidance robot 100 may determine whether or not to terminate the viewing guidance. For example, in a case where no visitors remain, the guidance robot 100 may move to a designated waiting location (or an initial location) after terminating the viewing guidance at the current location. Accordingly, no unnecessary resources are wasted, and the illogical situation where the docent service is continuously provided despite no visitors being present is eliminated.

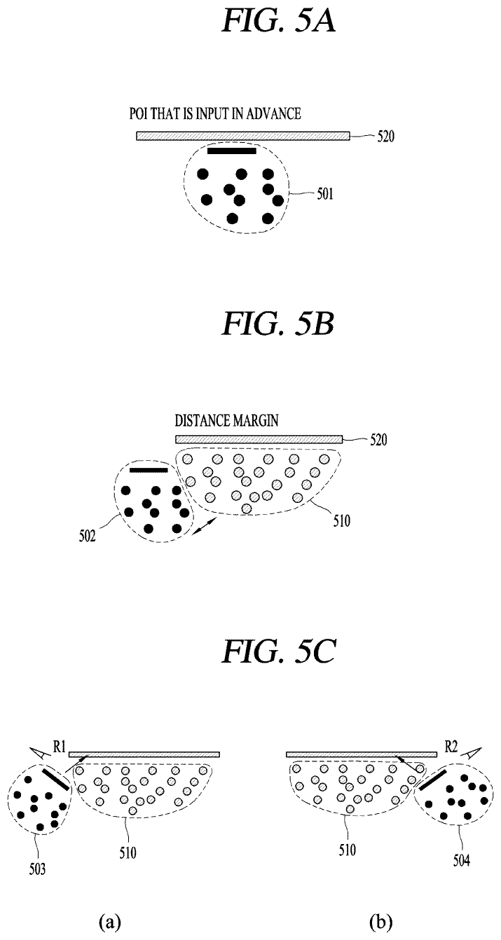

FIGS. 5A, 5B, and 5C are conceptual diagrams, respectively, that are referenced to describe a scenario in which the guidance robot according to the present disclosure modifies the arrival location in detail based on the degree of congestion in the vicinity of the target exhibition, for which guidance is provided.

Specifically, FIG. 5A illustrates a designated location that is input in advance into the guidance robot 100 capable of performing the docent function and, more particularly, a specific POI and a region in the vicinity of the specific POI. FIGS. 5B and 5C illustrate the arrival location, the angle, and the posture that are modified by the guidance robot 100 according to the present disclosure, based on the visitor information and, more particularly, the degree of congestion during viewing.

The processor 180 of the guidance robot 100 determines whether or not the guidance robot 100 can move to a first group of candidate points corresponding to a POI that is input in advance into the guidance robot. In a case where the guidance robot 100 cannot do so (e.g., in a case where visitors are present and the degree of visitor congestion is high), the processor 180 may determine one of candidate points in a second group corresponding to the arrival location of the robot, which is determined based on the visitor information, as the detailed location of the robot.

At this point, the relationships among the candidate points in the second group may correspond to those between the candidate points in the first group.

For example, the candidate points in the second group correspond to determined candidate clusters 502, 503, and 504, respectively, each of which includes arrival locations, as illustrated in FIGS. 5B and 5C, and one of the candidate points in the first group corresponds to a designated cluster 501 of locations, which is input in advance (pre-stored), as illustrated in FIG. 5A. At this point, the number of candidate points, the distances, and the like among the candidate points within each of the determined candidate clusters 502, 503, and 504 each of which includes arrival locations may match the number of candidate points, the distances, and the like among the candidate points within the designated cluster 501 of locations.

In a case where the degree of congestion during viewing is low, that is, in a case where many visitors are not present in the vicinity of the target exhibition, the guidance robot 100, as illustrated in FIG. 5A, determines the POI input in advance for a target exhibition 520, or a region in the vicinity of the POI, that is, the pre-stored designated cluster 501 of locations, as the arrival location.

When the degree of congestion during viewing is at or above a predetermined value, the guidance robot 100 determines the arrival location as a location or region that has a low degree of viewing congestion, according to the location of a visitor, the degree of visitor congestion, and the type of congestion, which are included in the arrival location. For example, as illustrated in FIG. 5B, in a case where the degree of congestion within a cluster 510 of visitors is at or above a predetermined value and the right side and the center are more congested than the left side, the guidance robot 100 may determine the candidate cluster 502 of arrival locations in the left side region of the target exhibition 520, from which the target exhibition can be viewed, as the arrival location.

The candidate cluster 502 of locations, as illustrated, may be determined to be a cluster of locations that is spaced a predetermined distance (margin distance) apart from the cluster 510 of visitors.

In addition, the posture or angle of the guidance robot 100 may be aligned in the direction that faces the target exhibition 510. At this point, the posture or angle of the guidance robot 100 may be modified according to the type of visitor congestion in the vicinity of the target exhibition 510.

For example, as illustrated in FIG. 5C, due to the type of congestion within the cluster 510 of visitors, (a) when the arrival location of the guidance robot 100 is determined to be the candidate cluster 503 of arrival locations, which is positioned to the left of the target exhibition 520, the posture/angle R1 of the body unit or the touchscreen of the guidance robot is adjusted in such a manner as to face the rightward direction. Furthermore, (b) When the arrival location of the guidance robot 100 is determined to be the candidate cluster 504 of arrival locations, which is positioned to the right of the target exhibition 520, the posture/angle R2 of the body unit or the touchscreen of the guidance robot is adjusted in such a manner as to face the leftward direction.

Although not illustrated, according to the type of congestion within the cluster 510 of visitors, the traveling-enabling unit may be rotated in such a manner as to face a location or region that is not congested. Thus, the detailed location or the posture/angle of either the body unit or the touchscreen of the guidance robot 100 may be modified. Accordingly, the cluster 510 of visitors is guided to move to a location or region that is not congested. Thus, the docent service may be provided in a more orderly manner.

In addition, the processor 180 of the guidance robot 100 may determine whether or not it is necessary to adjust the detailed location of the robot, based on the degree of visitor congestion in the vicinity of the target exhibition 520. According to the determination, the processor 180 may move to the detailed location or identify the detailed location. Then, the processor 180 may adjust the posture or gazing direction of the guidance robot 100.

Specifically, in response to the degree of visitor congestion in front of the target exhibition 520 reaching or exceeding a predetermined range, by controlling the traveling-enabling unit 130, the guidance robot 100 may adjust the detailed location of the robot in such a manner that the guidance robot 100 is located a predetermined distance away from the cluster 510 of visitors in the vicinity of the target exhibition 520. Then, the guidance robot 100 may adjust the posture or angle of the robot in such a manner as to face the target exhibition 520.

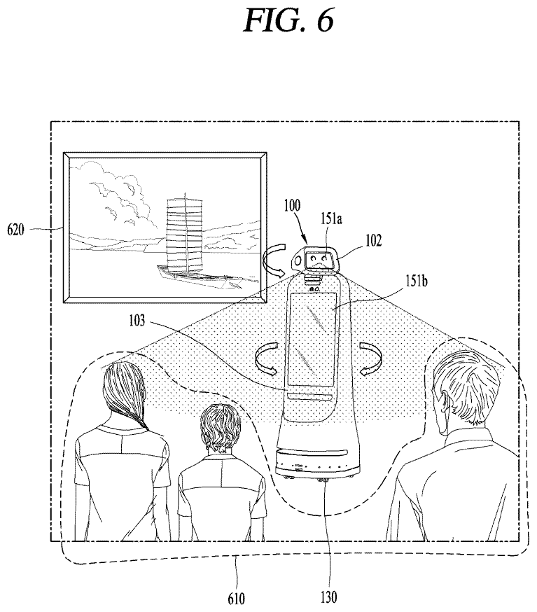

FIG. 6 is an exemplary conceptual diagram that is referenced to describe a scenario in which the guidance robot according to the present disclosure moves to the arrival location and then focuses attention on a location or region where a larger number of visitors are present, for an extended period.

With reference to FIG. 6, the guidance robot 100 according to the present disclosure may be divided into the head unit 102 and a body unit 103. The head unit 102 may include a first display 151a that is positioned on the upper portion of the robot and displays a change in the facial expression of the robot, In addition, the body unit 103 may include a second display 151b that is positioned between the head unit 102 and the traveling-enabling unit 130 and displays visual information associated with an explanation about a target exhibition 620.

According to one embodiment, the body unit 103 may be configured to include the second display provided on the front surface and a third display provided on the rear surface. In this case, a cluster 610 of visitors may be located in front of or behind the guidance robot 100. Therefore, the docent effect can be enhanced even in a case where a large number of visitors are present or the degree of congestion during viewing is high.

After moving to the determined arrival location, in order to monitor visitors gathering in the vicinity of the target exhibition, the guidance robot 100 may rotate the camera or rotate the body unit 103 or the head unit 102, on which the camera is mounted. Subsequently, the guidance robot 100 may recognize the face of a visitor and monitor the facial direction of the recognized face. Accordingly, the guidance robot 100 may control the traveling-enabling unit 130 in such a manner as to adjust the detailed location of the guidance robot 100 or to adjust the posture or angle of the guidance robot 100.

The processor 180 of the guidance robot 100 may align the center of the body unit 103 in such a manner that the second display 151b of the body unit 103 faces the facial direction of the cluster 610 of visitors included in the visitor information.

To this end, by rotating the drive wheels of the traveling-enabling unit 130, the processor 180 may modify the posture in such a manner that the center of the body unit 103 faces the cluster 610 of visitors.

In addition, while delivering an utterance associated with the target exhibition 620, on the basis of the facial density distribution that is monitored and included in the visitor information, the guidance robot 100 may control the display on the first display 151a in such a manner as to change the attention focus direction of the guidance robot 100.

According to one embodiment, the processor 180 of the guidance robot 100 may adjust the attention focus direction of the robot by controlling the display on the first display 151a of the head unit 102 in such a manner that the guidance robot 100 focuses attention on a point or region where the facial density distribution of the cluster 610 of visitors is at or above average, for an extended period.

For example, after monitoring the cluster 610 of visitors, the guidance robot 100 may display the gazing direction on the first display 151a in such a manner that the guidance robot 100 focuses attention on a location or region where the facial density distribution of the cluster 610 of visitors is high, for an extended period. In this manner, the docent effect where the guidance robot 100 delivers an utterance naturally and smartly as if making eye contact while providing an explanation to visitors may be achieved by performing processing in such a manner that the guidance robot 100 focuses attention on a place where a large number of visitors are present, for an extended period.

In addition, according to one embodiment, even after beginning to deliver a docent-style utterance about the target exhibition 620, the guidance robot 100 may continuously monitor the cluster 610 of visitors. As a result of the monitoring, when a change in the facial density distribution of visitors is detected, the guidance robot 100 may re-adjust the gazing direction and the distribution of the gazing direction on the first display 151a on the basis of the detected change.

In addition, according to one embodiment, after monitoring the cluster 610 of visitors, by analyzing changes in the facial expressions of the cluster 610 of visitors, the guidance robot 100 may rotate the head unit 102 or display the focus attention direction on the first display 151a in such a manner as to gaze for an extended period or more frequently at visitors who exhibits a high degree of concentration during viewing. To this end, values/level data associated with the degree of congestion during viewing, corresponding to various facial expressions of visitors, may be pre-stored in the memory 170 of the guidance robot 100.

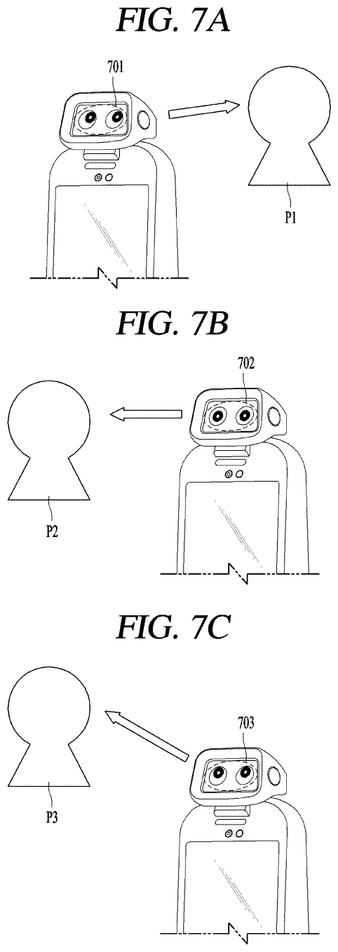

FIGS. 7A, 7B, and 7C are conceptual views that are referenced to describe examples in which the guidance robot according to the present disclosure adjusts the gazing direction at the arrival location in such a manner as to correspond to the facial directions of visitors.

As illustrated in FIGS. 7A to 7C, the gazing direction or the attention focus direction, which is displayed on the first display 151a of the guidance robot 100, indicates a change in the movement of the pupils of the guidance robot 100, which is displayed on the first display 151a. This creates the effect that the guidance robot 100 at the current location appears to look toward the faces of visitors P1, P2, and P3.

For example, as in FIG. 7A, in order to focus attention on the first visitor P1 located to the right of the guidance robot 100, the guidance robot 100 may display the images of the pupils that point toward (focus attention on) the first visitor P1, located on the right side, on the first display 151a.

In addition, for example, as illustrated in FIG. 7B, in order to focus attention on the second visitor P2 located in front of the center of the location of the guidance robot 100, the guidance robot 100 may display the images of the pupils that point toward (focus attention on) the second visitor P2, located in front of the center, on the first display 151a.

For example, as in FIG. 7C, in order to focus attention on the third visitor P3 located to the left of the location of the guidance robot 100, the guidance robot 100 may display the images of the pupils that point toward (focus attention on) the third visitor P3, located on the left side, on the first display 151a.

When it is detected that a visitor located in the attention focus direction moves or changes his/her facial direction, the guidance robot 100 monitors the face of the visitor and the facial direction of the visitor while readjusting the gazing direction leftward and rightward, and repeats the above-described process while delivering the docent-style utterance. Alternatively, the face of the visitor may be tracked for a predetermined time in such a manner that the gazing direction of the guidance robot 100 is directed toward the visitor who moves.

Accordingly, even when the visitor on whom the robot focuses attention no longer listens to the docent-style utterance or moves away, the guidance robot may naturally shift its gaze to an appropriate position rather than an empty place.

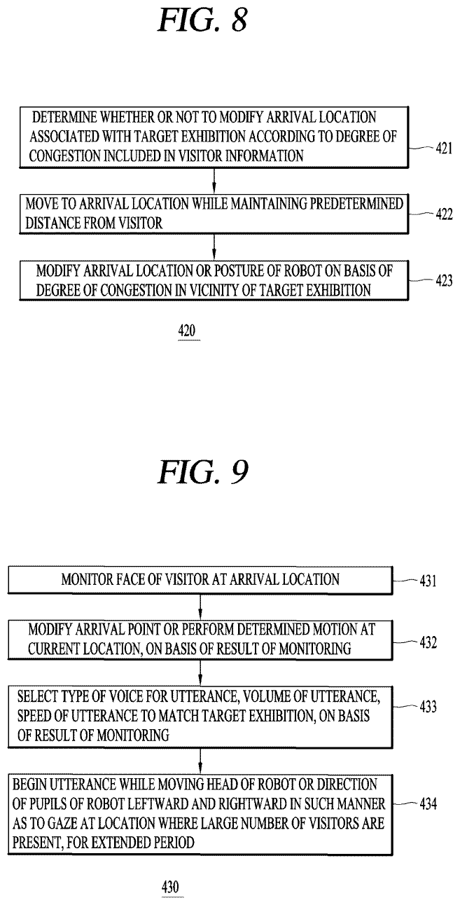

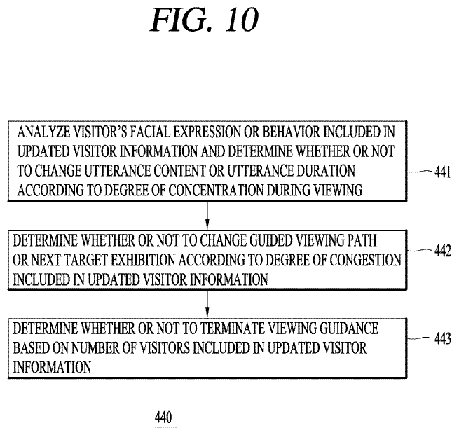

The detailed operation of each step included in the flowchart in FIG. 4 is described in detail below with reference to FIGS. 8, 9, and 10. The detailed operations of steps illustrated in FIGS. 8, 9, and 10 may also be performed as a sequence of detailed operations. Alternatively, as one separate embodiment, each detailed operation may also be performed independently. Alternatively, one or more detailed operations may also be omitted, or one or more detailed operations may be further included. Particularly, the detailed operations illustrated in FIG. 10 are not illustrated in a specific sequence and may be performed in various sequences different from the one illustrated.

FIG. 8 is a flowchart illustrating the detailed operations in which the guidance robot according to the present disclosure determines the arrival location associated with the target exhibition and moves to the determined location. In other words, the detailed operations associated with Step 420 in the flowchart in FIG. 4 are illustrated.

In one embodiment, the guidance robot 100 may determine, according to the degree of congestion during viewing, which is included in the visitor information, whether or not to modify the arrival location of the robot, which is associated with the target exhibition, for which guidance is provided (421).

The guidance robot 100 may modify the details of the arrival location based on the visitor information and/or may operate in such a manner as to modify the details of the arrival location on the basis of the degree of viewing congestion in the vicinity of the target exhibition.

At this point, the modifying of the details of the arrival location based on the visitor information may include modifying the detailed location in such a manner that the arrival location of the robot is spaced a predetermined distance apart from visitors, and modifying the posture or angle of the guidance robot on the basis of the facial direction of the visitor that is monitored at the arrival location.

In addition, the modifying of the details of the arrival location on the basis of the degree of viewing congestion in the vicinity of the target exhibition may include modifying the current details and angle (posture) of the guidance robot according to the degree of congestion during viewing and the type of congestion during viewing that are monitored at the arrival location.

In addition, the processor 180 of the guidance robot 100 may determine whether or not to change the guided viewing path or the next target exhibition, according to the degree of congestion during viewing, which is included in the updated visitor information.

For example, the guidance robot 100 may adaptively change the order of viewing, the path for viewing, and the target exhibition to be explained, in such a manner as to deliver a decent utterance in a smooth and smart manner. This adaptive change is based on the degree of spatial congestion, varying with the number of admitted visitors, the degree of congestion within a means of transportation, collected by communicating with an elevator for movement between floors, the degree of visitor congestion in the traveling direction of the guidance robot, and the like.

In one embodiment, when the arrival location is determined, the guidance robot 100 moves to the determined arrival location while maintaining a predetermined distance from visitors (422).

This is because, in a case where the guidance robot moves too slowly compared to visitors, the visitors feel bored and move away, thereby decreasing the guidance efficiency. Conversely, in a case where the guidance robot moves too fast compared to visitors, the visitors may struggle to keep up, thereby raising the risk of an accident. In this manner, the guidance robot is enabled to move to the next guidance robot in accordance with the moving speed of a visitor. Thus, the visitor using the docent service remains engaged with it without moving away. Consequently, the decent effect can also be further enhanced.

In addition, the guidance robot 100 may also guide, in advance, visitors moving ahead to the location of the next target exhibition.

In addition, the guidance robot 100 may adjust the traveling speed based on information about the distance between a visitor and the current location of the robot. Furthermore, using the information about the distance, the guidance robot 100 may modify the detailed location of the guidance robot or set or change the volume of an utterance.

For example, on the basis of the information about the distance, the guidance robot moves forward and backward in such a manner as to maintain a predetermined range of distances from visitors, and thus the location of the guidance robot may be adjusted. In addition, for example, the volume of an utterance for guidance may be increased on the basis of the information about the distance or information about the number of visitors following the guidance robot.

In one embodiment, on the basis of the degree of congestion in the vicinity of the target exhibition, the guidance robot 100 may modify the arrival location or the robot's posture (423).

For example, in a case where the vicinity of the target exhibition is congested, the arrival location may be modified to a less congested location or region on the basis of the type of congestion. In addition, in order to eliminate congestion, the guidance robot focuses attention on a less congested location or region, thereby encouraging visitors to voluntarily move to a non-congested location. In addition, for example, the posture of the guidance robot may be modified in such a manner as to point toward the direction in which the facial density distribution of visitors is high or in which congestion occurs, and toward the direction in which the target exhibition can be viewed.

FIG. 9 is a flowchart illustrating the detailed operations associated with a scenario in which the guidance robot according to the present disclosure adjusts the posture or gazing direction according to the facial direction of a visitor after moving to the arrival location. In other words, FIG. 9 illustrates the detailed operations associated with Step 430 in the flow chart in FIG. 4.

In one embodiment, after the guidance robot 100 moves to the determined arrival location, the guidance robot monitors the face of a visitor in the vicinity at the corresponding arrival point (431).

For example, through a vision sensor, such as a camera, the guidance robot 100 monitors the face of a visitor gathering in the target exhibition and the facial direction of the visitor while moving the head unit or the gazing direction of the head unit leftward and rightward.

In one embodiment, on the basis of the result of the monitoring, the guidance robot may modify the arrival location or perform a determined motion at the current location (432). At this point, the term “determined motion” refers to a predetermined specific operation (e.g., leftward and rightward movement of the head) and a change in facial expression (e.g., eye blinking), and indicates confirmed recognition of the arrival location.

In one embodiment, on the basis of the result of the monitoring, the guidance robot 100 may selectively adjust the type of voice for an utterance, the volume of an utterance, and the speed of an utterance to match the target exhibition (433).

To this end, on the basis of the result of the monitoring, the guidance robot 100 may identify the visitor information about a visitor present in the vicinity of the target exhibition, for example, primary visitor demographics (e.g., identifying whether visitors are family members, whether they include children, or whether they belong to a similar category), gender, and age bracket.

For the type of voice for an utterance, a TTS engine operating in conjunction with the guidance robot may be selected in such a manner that voice is selected in a manner appropriate for a visitor's gender and age bracket. Accordingly, a friendlier docent service can be provided to visitors.

The greater the number of visitors, the greater the separation distance from the robot, and the higher the age bracket of the visitors, the greater the increase in the volume of an utterance. In addition, in a case where the age bracket of visitors is below or above average or where the primary visitor demographics indicate that visitors are family members, the speed of an utterance may be reduced below a reference value.

In one embodiment, the guidance robot 100 may begin to deliver an utterance while moving the head of the robot or the gazing direction of the pupils of the robot leftward and rightward in such a manner as to focus attention on a location or region where a large number of visitors are present, for an extended period (434). By performing this operation before beginning to deliver an utterance, a visitor's concentration during viewing can be further enhanced.

FIG. 10 is a flowchart illustrating the detailed operations associated with a scenario in which the guidance robot according to the present disclosure determines the next operation on the basis of the visitor information updated before, after, or while delivering an utterance about the target exhibition. In other words, FIG. 10 illustrates the detailed operations associated with Step 440 in the flow chart in FIG. 4.

When the docent service begins, the guidance robot 100 may acquire and update the visitor information continuously and in real time through a vision sensor, such as a camera.

In one embodiment, the guidance robot 100 may analyze a visitor's facial expression or behavioral change, which is included in the updated visitor information, and, on the basis of the degree of concentration during viewing, resulting from the analysis, determine whether or not to modify the utterance content or the utterance duration (441).

At this point, content for an initial utterance may be selected according to visitor characteristics, such as primary visitor demographics and age bracket, which result from monitoring visitors. For example, in a case where the age bracket of visitors is below or above a reference level, the content difficulty level may be lowered, and then an utterance may begin.

While a docent-style utterance for this initial utterance content is delivered, when boredom or difficulty in understanding is detected from a visitor's monitored facial expression and/or behavioral change, without stopping the delivery of the content, the guidance robot 100 may switch to utterance content with engaging elements (e.g., a quiz, an anecdote, and the like) and proceed with the new utterance content. Alternatively, the guidance robot 100 may change utterance content by adjusting the content length, for example, in the form of a summary.

In addition, although an utterance is in progress, when a situation that does not meet a viewing condition is detected, the guidance robot 100 may change the type of utterance content in such a manner as to deliver regulatory guidance (e.g., “Not allowed to carry a pet.”).

In one embodiment, on the basis of the degree of congestion included in the updated visitor information, the guidance robot 100 may determine whether or not to change a guided viewing path or the next target exhibition (442).

For example, in a case where it is determined that the degree of spatial congestion makes it difficult for the guidance robot 100 to travel along a designated guided viewing path or that visitor characteristics require a change in the movement path to the next target exhibition or a means of transportation, the order of viewing, the guided viewing path, and the next exhibition, for which guidance is provided, may be modified for guidance in a manner appropriate for the situation.

For example, in a case where the space within an elevator is congested when visitors move between floors, they are guided to use stairs. Alternatively, in a case where visitors use an assistive apparatus (a wheelchair or a pair of crutches), guidance along a path that allows convenient movement may be additionally provided.

Alternatively, for example, in a case where the order of viewing is changed and then exhibitions are explained beginning from an exhibition with a low degree of congestion during viewing, or where the degree of congestion in the vicinity of the target exhibition is high, a docent-style utterance may be provided with a reduced utterance content length or duration.

In addition, in one embodiment, based on the number of visitors included in the updated visitor information, the guidance robot 100 may determine whether or not to terminate the viewing guidance (443).

Specifically, when it is determined, through a vision sensor, such as a camera, that no visitors remain present, the processor 180 of the guidance robot 100 may recognize that guidance along the viewing path is complete, and terminate the viewing guidance without providing guidance to the next target exhibition. Subsequently, the guidance robot 100 may move to the designated waiting location or autonomously move to a location that meets a setting condition (e.g., a location or region that has a low level of congestion).

In the related art, the viewing guidance is terminated when completing guidance along a predesignated guidance path or when a user or manager presses a cancellation button (or inputs another command). This limitation can be addressed accordingly.

The guidance robot according to one or several embodiments of the present disclosure and a method of operating the guidance robot can modify a pre-stored designated location according to the number of visitors in the vicinity, which is included in the visitor information, and the degree of congestion in the vicinity. Even after the guidance robot moves to the corresponding location, according to the direction in which a visitor gazes, the degree of congestion, and the location of the target exhibition, the guidance robot and the method of operating the guidance robot can adjust the detailed location or can appropriately adjust the posture, angle, and gazing direction of the guidance robot. Accordingly, visitors provided with the service can feel a sense of friendliness, similar to when a human docent provides guidance, and concentrate on viewing.

As described above, the guidance robot according to one or several embodiments of the present disclosure and the method of operating the guidance robot can enable the monitoring of the characteristics of visitors who gather in the vicinity of the target exhibition, thereby accordingly delivering an utterance using the type of voice, the volume, and the speed. Furthermore, the guidance robot and the method of operating the guidance robot can enable the monitoring of the degree of a visitor's congestion during viewing, thereby adjusting the utterance content or the utterance duration. As a result, the degree of a visitor's concentration during viewing and the degree of a visitor's comprehension of the content be enhanced. In addition, the stored guided viewing path or the next target exhibition to be explained can be flexibly modified according to the degree of congestion during viewing, thereby enhancing the docent effect. In addition, when moving to the next target exhibition, the guidance robot can travel in accordance with the moving speed of a visitor, thereby proceeding to the next explanation without any delay. As a result, visitors receiving the docent service can remain fully attentive to the explanation. In addition, while the viewing guidance is in progress, if it is determined that the docent service no longer needs to be provided, such as when all visitors leave, the guidance robot can autonomously terminate the service without additional input from the manager and move to a waiting location. Accordingly, no unnecessary resources are wasted, and the illogical situation where the docent service is continuously provided despite no visitors being present is eliminated.

Further scope of applicability of the present disclosure will become apparent from the following detailed description. However, since it could be clearly understood by those skilled in the art various changes and modifications are made within the spirit and scope of the present disclosure, the detailed description and specific embodiments such as preferred embodiments of the present disclosure should be understood as being given only as examples.

The features, structures, effects, and the like described in the embodiments above are included in at least one embodiment of the disclosure, and are not necessarily limited to only one embodiment. Furthermore, the features, structures, effects, and the like illustrated in each embodiment may be combined or modified and implemented in other embodiments by a person skilled in the art to which the embodiments pertain. Therefore, the contents related to these combinations and modifications should be interpreted as being included within the scope of the disclosure.

Although the above description has been made focusing on embodiments, these are merely examples and do not limit the disclosure, and it will be understood by those skilled in the art to which the disclosure pertains that various modifications and applications not exemplified above are possible without departing from the essential characteristics of the embodiments. For example, each component specifically shown in embodiments may be modified and implemented. Differences relating to these modifications and applications should be construed as being included within the scope of the disclosure as defined in the appended claims.

1. A guidance robot comprising:
a sensor for acquiring visitor information in the vicinity;
a processor that determines an arrival location associated with a target exhibition based on the visitor information; and
a traveling-enabling unit for moving the guidance robot to the determined arrival location,
wherein the processor adjusts the posture or gazing direction of the guidance robot at the determined arrival location in such a manner as to correspond to the facial direction of a visitor included in the visitor information, and determines the next operation on the basis of the visitor information updated during an utterance about the target exhibition.

2. The guidance robot of claim 1, wherein the processor determines at the determined arrival location whether or not the detailed location of the guidance robot needs to be adjusted, based on the degree of congestion in the vicinity of the target exhibition, and, after moving or identifying the detailed location according to the determination, adjusts the posture or gazing direction of the guidance robot.

3. The guidance robot of claim 2, wherein, in response to the degree of congestion in the vicinity of the target exhibition reaching or exceeding a predetermined range, by controlling the traveling-enabling unit, the processor adjusts the detailed location of the guidance robot in such a manner as to be located at a point located a predetermined distance from the visitor in the vicinity of the target exhibition, and adjusts the angle of the guidance robot in such a manner that the guidance robot faces the target exhibition.

4. The guidance robot of claim 3, wherein, when it is determined that the guidance robot is unable to move to candidate points in a first group, which correspond to a POI that is input in advance, the processor determines one of candidate points in a second group, which correspond to the arrival location of the guidance robot, which is determined based on the visitor information, as the detailed location of the guidance robot, and
wherein the relationships among the candidate points in the second group correspond to the relationships among the candidate points in the first group.

5. The guidance robot of claim 4, further comprising:
a display that is mounted on the front-facing surface of the body of the guidance robot and displays visual information associated with the target exhibition,
wherein, in response to the degree of congestion in the vicinity of the target exhibition reaching or exceeding the predetermined range, the processor rotates the front-facing surface of the body of the guidance robot in such a manner that the display faces the direction in which the degree of congestion is at or below average.

6. The guidance robot of claim 1, wherein the sensor for acquiring the visitor information includes at least one of the following: a camera, a 3D depth camera, a LiDAR, or a proximity sensor.

7. The guidance robot of claim 1, wherein the guidance robot is divided into a head unit including a first display that is positioned on the upper portion and displays a change in the facial expression of the guidance robot, and a body unit including a second display that is positioned between the head unit and the traveling-enabling unit and displays visual information associated with an explanation about the target exhibition, and
wherein the processor aligns the center of the body unit in such a manner that the second display faces the facial direction of the visitor included in the visitor information, and controls the display on the first display on the basis of the facial density distribution, which is included in the visitor information, in such a manner as to change the attention focus direction of the guidance robot.

8. The guidance robot of claim 7, wherein the processor adjusts the attention focus direction of the guidance robot by controlling the first display in such a manner that the guidance robot focuses attention on a point or region where the facial density distribution of the visitors is at or above average, for an extended period.

9. The guidance robot of claim 1, wherein, when the guidance robot moves to the determined arrival location, the processor adjusts the traveling speed of the guidance robot through the traveling-enabling unit in such a manner that the guidance robot maintains a predetermined distance from a visitor.

10. The guidance robot of claim 1, further comprising:
a speaker that is mounted on the guidance robot and outputs an utterance about the target exhibition,
wherein, before the utterance about the target exhibition begins, the processor analyzes the characteristics of a visitor, corresponding to the visitor information, and adjusts at least one of the following: the type of voice for the utterance, the volume of the utterance, or the speed of the utterance.

11. The guidance robot of claim 1, wherein the processor analyzes a visitor's facial expression or behavioral change, which is included in the visitor information, and, on the basis of the degree of concentration during viewing, resulting from the analysis, determines whether or not to change the content of an utterance about the target exhibition or to adjust the duration of the utterance.

12. The guidance robot of claim 1, further comprising:
a memory in which a viewing path, along which the guidance robot provides guidance within a predetermined space, and information about the target exhibition are stored,
wherein the processor determines whether or not to modify the stored viewing path, based on the degree of congestion, which is included the visitor information, and determines whether or not change the next target exhibition, based on the degree of congestion in the vicinity of the target exhibition to be explained.

13. The guidance robot of claim 12, wherein the processor determines whether or not to change the stored viewing path or a stipulated regulatory guidance approach, on the basis of the characteristics of a visitor, which are included in the visitor information.

14. The guidance robot of claim 12, wherein the processor determines whether or not to provide guidance to the next target exhibition, on the basis of the number of remaining visitors, which is included in the updated visitor information, during an utterance about the target exhibition.

15. The guidance robot of claim 14, wherein, when it is determined through the sensor that the number of remaining visitors, which is included in the updated visitor information, is not present, the processor recognizes that guidance along the viewing path is complete and terminates viewing guidance without providing guidance to the next target exhibition.

16. A method of operating a guidance robot, the method comprising:
a step of acquiring visitor information in the vicinity;
a step of determining an arrival location associated with a target exhibition based on the visitor information and moving the guidance robot to the determined arrival location;
a step of adjusting the posture or gazing direction of the guidance robot in such a manner as to correspond to the facial direction of a visitor included in the visitor information; and
a step of determining the next operation on the basis of the visitor information updated during an utterance about the target exhibition.

17. The method of claim 16, wherein the step of determining the arrival location associated with the target exhibition and moving the guidance robot to the determined arrival location comprises:
a step of determining whether or not to modify the arrival location associated with the target exhibition according to the degree of congestion, which is included in the visitor information;
a step of moving the guidance robot to the next arrival location while maintaining a predetermined distance from the visitor; and
a step of modifying the arrival location or the posture of the guidance robot on the basis of the degree of congestion in the vicinity of the target exhibition.

18. The method of claim 16, wherein the step of the posture or gazing direction of the guidance robot in such a manner as to correspond to the facial direction of the visitor included in the visitor information, comprises:
a step of monitoring the face of the visitor at the arrival location through a sensor;
a step of modifying the arrival location or performing a predetermined motion at the current location, on the basis of the result of the monitoring;
a step of adjusting the type of voice for the utterance, the volume of the utterance, or the speed of the utterance, on the basis of the result of the monitoring; and
a step of beginning the utterance while moving the head of the guidance robot or the gazing direction of the pupils of the guidance robot leftward and rightward in such a manner that the guidance robot focuses attention on a location or region where a large number of visitors are present, for an extended period.

19. The method of claim 16, wherein the step of determining the next operation on the basis of the visitor information updated during the utterance about the target exhibition, comprises:
a step of analyzing the visitor's facial expression or behavioral change, which is included in the updated visitor information, and determining whether or not to modify the content of the utterance or the duration of the utterance, on the basis of the degree of concentration during viewing, resulting from the analysis;
a step of determining whether or not to change a guided viewing path or the next target exhibition, on the basis of the degree of congestion, which is included in the updated visitor information; and
a step of determining whether or not to terminate viewing guidance, based on the number of visitors, which is included in the updated visitor information.
